(19) United States
(12) Patent Application Publication
(10) Pub. No.: US 2019/0378059 A1
(43) Pub. Date: Dec. 12, 2019

(54) METHOD FOR EVALUATING MAPPING SOURCES TO DETERMINE THE MOST PROFITABLE AND EFFICIENT ROUTE FOR GIG-ECONOMY DRIVERS

(71) Applicants: David Jerrold Levy, Bethlehem, PA (US); Nicolaos Demetrius Chaikalis, Lehighton, PA (US)

(72) Inventors: David Jerrold Levy, Bethlehem, PA (US); Nicolaos Demetrius Chaikalis, Lehighton, PA (US)

(21) Appl. No.: 16/433,751

(22) Filed: Jun. 6, 2019

Related U.S. Application Data
(60) Provisional application No. 62/681,283, filed on Jun. 6, 2018.

(51) Int. Cl. G06Q 10/04; G06Q 50/30; G08G 1/0968; G01C 21/34; G06Q 30/02

(52) U.S. Cl. CPC G06Q 10/047; G06Q 50/30; G06Q 30/0284; G01C 21/3453; G08G 1/096838

(57) ABSTRACT

A software application enabling gig-economy drivers to evaluate routes from mapping sources to determine the most profitable and efficient routes is provided. The computer-implemented method is adapted to determine the most profitable route, the software application reviews all routes returned by the mapping APIs and then prioritizes the longest available mile route within an acceptable time variance from the default route provided to the driver in the gig-economy service application.

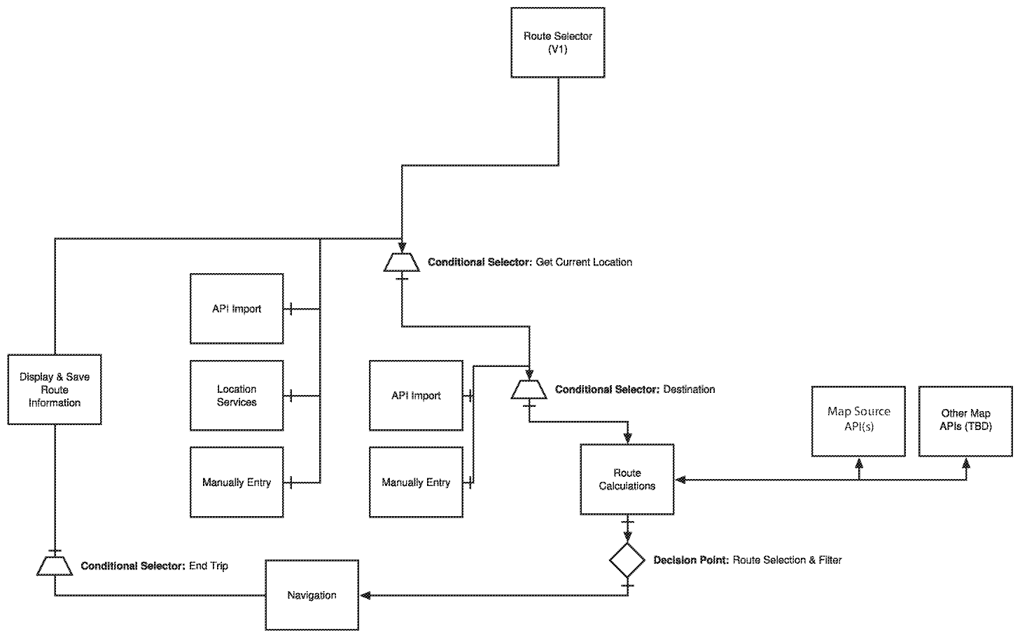

### CROSS-REFERENCE TO RELATED APPLICATION

This application claims the benefit of priority of U.S. provisional application No. 62/681,283, filed 6 Jun. 2018, the contents of which are herein incorporated by reference.

### BACKGROUND OF THE INVENTION

The present invention relates to computer-implemented mapping methods and, more particularly, to a mobile and web-based application enabling gig-economy drivers (i.e. rideshare, food delivery, cargo transportation, etc. drivers) to evaluate routes from mapping sources to determine the most profitable and efficient routes.

Gig-economy drivers are not able to achieve optimal compensation on a per ride basis due to the current payout structure provided by the gig-economy companies they work for. These gig-economy service provider systems pay the driver for time and distance (minutes and miles), while the current GPS-routing mapping systems, as well as other conventional methods aim to minimize both.

Conventional methods involving choosing the route with the most miles for the optimal compensation take too much time for the driver to search and choose the most profitable route to maximize their earnings since the conventional method usually only offers one to three choices with the seemingly highest mileage option not being the actual route to a destination, rather supplying drivers with the least-mile route in order for the gig-economy companies to maximize their profits while reducing the payout to drivers.

Even computer-implemented options provide limited route choice options for gig-economy drivers because such methods are designed for public use, not the specific commercial use of gig-economy drivers.

As can be seen, there is a need for a mobile and web-based application enabling gig-economy drivers (i.e. rideshare, food delivery, cargo transportation, etc. drivers) to evaluate routes from mapping sources to determine the most profitable and efficient routes. The present invention is specifically designed to increase the profits of gig-economy drivers on a “per ride” basis. The present invention draws from mapping source not previously used, as well as, some with current integrations, generating multiple route options with the most profitable being at the top and showing the dollar amount the driver will earn by taking each route for simple comparison, thus making it easier and faster to make a profitable decision.

The economics of gig-economy drivers are such that the more rides a gig-economy driver can engage in, the more profitable their day's work will be. Likewise, maximizing the profits of each ride would also be a boon in the fast-paced commercial space gig-economy drivers work in. As a result, the present invention improves the profitability of computer-implemented mapping services for fast-paced gig-economy drivers, who are inherently coupled to the computer network of the gig-economy service provider they work for.

### SUMMARY OF THE INVENTION

In one aspect of the present invention, a method for enabling gig-economy drivers to determine the profitability of a plurality of computer-generated mapping routes provided from one or more mapping sources includes the following: providing a systemic software application compatible with a computing device coupled to a gig-economy service software application associated with a gig-economy driver; prompting, by way of the systemic software application, the gig-economy driver for a time variance; and prioritizing, by way of the systemic software application, each route of the plurality of routes within the time variance from a datum time for a default route provided by the gig-economy service software application.

In another aspect of the present invention, the above method for enabling gig-economy drivers to determine the profitability of a plurality of computer-generated mapping routes provided from one or more mapping sources, and wherein the systemic software application is configured to prompt the gig-economy driver to selectively input the time variance, wherein the systemic software application is configured to prompt the gig-economy driver to selectively input the time variance, wherein the time variance is limited based in part on a distance between the entered starting location and the entered destination location, or wherein the time variance is a default time variance of two minutes. It being understood that the time variance may range between one and twenty minutes, or more or less, or be a default set time which is a percentage of the overall distance of the entered starting and destination location.

These and other features, aspects and advantages of the present invention will become better understood with reference to the following drawings, description and claims.

### BRIEF DESCRIPTION OF THE DRAWINGS

The sole FIGURE is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a software application enabling gig-economy drivers to evaluate routes from mapping sources to determine both the most profitable and efficient routes. When determining the most profitable route, the software application reviews all routes returned by the mapping APIs and then prioritizes the longest available mile route within an acceptable time variance from the default route provided to the driver in the gig-economy service application.

Referring to the sole FIGURE, the present invention may include at least one computer or mobile device with a user interface. The computer or mobile device may include at least one processing unit coupled to a form of memory. The computer or mobile device may include, but not limited to, a microprocessor, a server, a desktop, laptop, and smart device, such as, a tablet and smart phone. The computer or mobile device includes a program product including a machine-readable program code for causing, when executed, the computer to perform steps. The program product may include software which may either be loaded onto the computer or mobile device or accessed by the computer or mobile device. The loaded software may include an application on a smart device. The software may be accessed by the computer using a web browser or through a native app for that device's operating system. The computer or mobile device may access the software via the web browser using the internet, extranet, intranet, host server, internet cloud and the like.

The method embodied in the present invention may include the following steps: first, a gig-economy driver-user may input a starting address via either manual input or via a geolocation functionality of their mobile device; then, the driver-user may input a destination address via either manual input or via API input from an external application, such as a gig-economy service provider system (Uber™, Lyft™ DoorDash™, etc.); next, starting and ending destinations are sent out to one or more mapping APIs; then, the one or more mapping APIs return all viable routes from their respective system; finally, the returned routes are organized and filterable according to profitability, speed and/or time at the users selection. From there, the driver-user chooses the route to follow and the relevant GPS-based mapping system guides the driver-user through the chosen route.

The software application is for use on any portable or mobile computing device which has the ability to transmit location details. Using a compatible mobile device, the driver-user can input a starting location either through manual entry or through geolocation functionality. After the starting location is identified, the driver-user then enters a trip destination. This information can be manual entered by the driver-user or imported through an API provided by the gig-economy service. Once starting and ending destinations are established, the driver-user can choose to find routes. At that point, the request is sent out to mapping source APIs. The mapping source APIs then return all available routes as per the individual mapping sources. These routes may then be filtered within the application to determine the most profitable or most efficient route for the driver to maximize earnings. Routes may be displayed with a + or − ranking to show the cost benefit over the default travel route provided by the gig-economy service provider system.

Within the software application, the logic process is used to determine the most profitable or most efficient routes of this inherent internet-based challenge by comparing the available routes supplied by the mapping source API(s) to the default route chosen by the gig-economy service provider; thereby, the present invention improves the profitability of computer-implemented mapping services for fast-paced gig-economy drivers. When determining the most profitable route, the application reviews all routes returned by the mapping APIs and then prioritizes the longest available mile route within an acceptable time variance from the default route provided to the driver in the gig-economy service application. When determining the most efficient route for a driver, the application evaluates all the routes provided by the mapping APIs in terms of profitability (mileage) in view of the fastest route, and an acceptable time variance from said fastest route and/or said default. The software application may prompt the driver-user to selectively set the acceptable time variance based in part on the total distance between the entered starting and destination addresses. In other embodiments, the present invention would be working with a default time variance.

Map APIs that may be used include, but are not limited to, Mapbox, HERE map API, APPLE Mapkit JS, Waze, Google Maps, OpenStreet. Map API types that may be used include, but are not limited to, Geocode Directions Navigation (for GPS navigation).

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for enabling gig-economy drivers to determine the profitability of a plurality of computer-generated mapping routes provided from one or more mapping sources, comprising:
providing a systemic software application compatible with a computing device coupled to a gig-economy service software application associated with a gig-economy driver;
retrieving, by way of the systemic software application, a plurality of computer-generated mapping routes provided from one or more mapping sources based in part on an entered starting location and an entered destination location;
receiving, by way of the systemic software application, a time variance associated with the gig-economy driver; and
prioritizing, by way of the systemic software application, each route of the plurality of routes within the time variance from a datum time for a default route provided by the gig-economy service software application.

2. The method of claim 1, wherein the systemic software application is configured to prompt the gig-economy driver to selectively input the time variance.

3. The method of claim 1, wherein the systemic software application is configured to prompt the gig-economy driver to selectively input the time variance, wherein the time variance is limited based in part on a distance between the entered starting location and the entered destination location.

4. The method of claim 3, wherein the time variance is a default set time or percentage of said distance.
